(19) United States
(12) Patent Application Publication
(10) Pub. No.: US 2004/0165011 A1
(43) Pub. Date: Aug. 26, 2004

(54) SYSTEMS AND METHODS FOR CONTROLLING USER-CONTROLLED DEVICES USING DATA STORED ON A PORTABLE STORAGE MEDIUM

(76) Inventor: David QUIJANO, Magnolia, TX (US)

Correspondence Address: OLIFF & BERRIDGE, PLC., P.O. BOX 19928, ALEXANDRIA, VA, 22320, US

(21) Appl. No.: 10/248,879

(22) Filed: Feb. 26, 2003

(51) Int. Cl. G09G 5/00

(52) U.S. Cl. 345/821

(57) ABSTRACT

Data stored on a storage medium is used to operate and/or control a user-controlled device. The data may be stored onto the storage medium at a remote location using a programming device which is capable of programming and/or storing the data onto the storage medium. The data is read/received from the storage medium using a storage medium reading device and the read/received data is used operate the image forming device. A programmed storage medium may be used instead of, or in addition to, the control panel associated with a user-controlled device to operate and/or control the user-controlled device.

### BACKGROUND OF THE INVENTION

1. Field of Invention

This invention relates to systems and methods for controlling a user-controlled device, such as, for example, an image forming device, by using data stored on a storage medium.

2. Description of Related Art

User-controlled devices, such as, for example, image forming devices, include a control panel with various buttons and/or a touch-sensitive liquid crystal display for users to manipulate to input desired commands and/or settings. The control panel allows users to input desired settings and/or to request various functions. Generally, users select from the settings and/or functions available on the control panel by depressing a button or touching an area or item on the touch sensitive screen.

Control panels have increased in complexity as the number of functions and settings available to users has increased. Although the number of settings and functions to which control panels provide users access has increased, control panels have remained approximately the same in size and in many cases, have decreased in size in order to provide smaller devices.

Thus, users may have difficulty reading the control panel or display, understanding how to input desired settings and/or functions and/or physically inputting desired settings/commands/functions when operating the control panel or display, especially a smaller control panel or display with increased functionality. In addition, some users may have difficulty accessing and/or seeing the control panel or display due to the position of the control panel or display on the user controlled device.

### SUMMARY OF THE INVENTION

Individuals with physical disabilities may have increased difficulty and may, in fact, not be able to select desired settings and/or functions from a control panel on a user-controlled device. It is possible to include special components with the control panel, which facilitate use of the control panel by individuals with physical disabilities. However, individuals have varying physical disabilities such that incorporating features into the control panel and/or positioning the control panel at a location to allow at least a substantial number of individuals with various physical disabilities to use the control panel can be costly, challenging and space consuming.

For example, for individuals confined to a wheelchair, many control panels are not easily accessible. The control panel of a copy machine, for example, is usually provided on an upper surface of the copy machine. Further, the majority of copy machines used in the workplace are relatively large. Thus, the majority of the copy machines used in the workplace have control panels that are located above the line of sight of individuals confined to a wheelchair. As a result, such individuals may not be able to read or operate the control panel.

For persons with other disabilities, the height or placement of the control panel may not be the only feature that hinders use of the user-controlled device. Many individuals with disabilities have computers which are equipped with special user-interface aids which allow the individuals to operate the computers. Although it would be possible to incorporate such user-interface aids for each user-controlled device, it would be costly and space consuming.

Compliance with the Americans with Disabilities Act is an important feature of user-controlled devices. This invention provides convenient systems and methods for individuals with disabilities to operate and/or set controls of a user-controlled device.

A user-controlled device is a device which a user operates/controls via a control panel associated with the device. User-controlled devices are employed in a wide-variety of environments and for a wide-variety of purposes. For example, user-controlled devices include, but are not limited to, copy machines, facsimile devices, scanners, printers, point of sale terminals, automated information/transaction kiosks, stereos, recording devices, televisions/VCRs, and computers.

In various exemplary embodiments of the systems and methods of this invention, a user can program a storage medium with data regarding the desired functions and/or settings in the privacy of their own office/home, take the programmed storage medium to the desired user-controlled device, i.e., the target user controlled device, and use the storage medium to instruct the user-controlled device to carry-out the desired functions and/or settings. In various exemplary embodiments, to operate/control the target device, the user provides the programmed storage medium to the target device, by, for example, placing the programmed storage medium on the storage medium reading device, such as, for example, a scanner. In other exemplary embodiments, the user may provide the programmed storage medium to the target device by moving the storage medium to within a sufficient distance of a storage medium reading device which scans/reads/receives the data programmed on the storage medium. In other exemplary embodiments, similar to inserting a computer disk into a disk drive, the user may provide the programmed storage medium to the target device by inserting the storage medium into an input portion of the storage medium reading device. However, in contrast to the process when a user stores a program and/or data/file on a computer disk and later inserts the disk to access the data/file and/or operate the program, the user does not need to operate the user interface to open the file/program and use the data and/or run the program, but is only required to provide the programmed storage medium to the storage medium reading device. The target device automatically reads/scans/processes the data stored on the programmed storage medium and initiates the programmed settings/functions.

In the various exemplary embodiments of the systems and methods of this invention, by providing the programmed storage medium to the target device, the target device reads/receives the data programmed on the storage medium and the target device automatically, without requiring additional user intervention, adjusts/initiates the desired settings and/or commands. Thus, the user is able control the target device without having to operate the control panel on the target device.

However, it should be appreciated that the user may, in various exemplary embodiments, be required to provide the user-controlled device with the data on which the desired function is to be performed. For example, if the desired function is to make a copy of a document, the user may need to provide the copier with the original document so that the copier can carry out the desired function, i.e., make a copy.

Thus, in the various exemplary embodiments of the systems and methods according to this invention, once the user provides the user-controlled device with the programmed storage medium and, if necessary, the data necessary to carry out the desired function, the user is not required to do any thing else. For example, if the user desires to fax a letter to multiple locations, the user can, according to the various systems and methods of this invention, program a storage medium with the command for faxing a document and the fax numbers of each of the desired locations. The user can then provide the programmed storage medium to the fax machine along with the letter to be faxed.

In various exemplary embodiments of this invention, the user may also store the letter on the storage medium. Accordingly, the user would only need to provide the programmed storage medium to the fax machine.

It should also be appreciated that the user may also use the control panel to enter additional commands and/or settings or may be prevented from using the control panel when the programmed storage medium is provided to the target device.

In various exemplary embodiments of the systems and methods according to this invention, the user can, for example, view a control panel corresponding to the control panel of a user-controlled device on his/her computer. The user may then operate his/her computer to program any of the settings and/or functions that are available to an individual using the control panel of the user-controlled device. Thus, instead of struggling to obtain physical access to the control panel to input the desired settings/functions, the user can select and store, on the storage medium, the desired functions and/or settings by operating his/her computer. For example, the user may “operate” or select commands using an image of the control panel displayed by the computer. The user can then use the programmed storage medium to operate/control the target user-controlled device for example, as described above.

In various exemplary embodiments of the systems and methods of this invention, the user-controlled devices either have a storage medium reading device incorporated therein, or are associated with an external storage medium reading device.

Further, according to various exemplary embodiments of this invention, existing systems and devices can be brought into compliance with the American's with Disabilities Act without having to physically provide either an additional control panel at a handicap accessible location on the user-controlled device and/or extensively modifying the user-controlled device to re-position the control panel or to provide a wide-variety of user-interface devices. In various exemplary embodiments of this invention, the existing control panel of a system or device can be made accessible to individuals with disabilities by either installing a storage medium reading device on or within the existing user-controlled device or providing an external storage medium reading device with which the user-controlled device is associated.

This invention provides systems and methods for operating/controlling a user-controlled device without using the control panel associated with the user-controlled device.

This invention separately provides systems and methods for using data stored on a storage medium to automatically operate and/or control a user-controlled device.

This invention separately provides systems and methods for individuals with disabilities to operate and/or set controls of a user-controlled device.

This invention separately provides systems and methods for programming a storage medium with one or more desired functions and/or settings for a target user-controlled device and providing the programmed storage medium to the target user-controlled device to automatically control and/or initiate the target user-controlled device.

This invention separately provides systems and methods for programming a storage medium with one or more desired functions and/or settings for a target user controlled device and with data on which the desired functions and/or settings are to be performed or applied, and providing the programmed storage medium to the target user-controlled device to automatically control and/or initiate the target user-controlled device.

This invention separately provides systems and methods for programming a storage medium with one or more desired functions and/or settings for a target user-controlled device using a computer which displays an image of the control panel associated with the user-controlled device.

This invention separately provides systems and methods for automatically initiating and/or performing settings and/or functions of a user-controlled device when a storage medium, storing selected settings and/or functions, is provided to a storage medium reading device associated with the user-controlled device.

This invention separately provides a personal computer with a graphical user interface that simulates a control panel of a user-controlled device.

This invention separately provides systems and methods for using a programmed storage medium to automatically control a user-controlled device.

This invention separately provides systems and methods for using a programmed and portable storage medium to automatically control a remote user-controlled device.

This invention separately provides systems and methods which require less space than systems having a wide variety of user-interface aids that would allow persons with various disabilities to use the user-controlled device, even if the storage medium reading device is located independently of the user-controlled device.

This invention separately provides systems and methods which help eliminate the need for devices to have a front mounted and/or low-level mounted control panel that would be accessible for an individual sitting in a wheelchair in order to be usable by individuals with disabilities and to be in compliance with the Americans with Disabilities Act.

This invention separately provides systems and methods for controlling a target user-controlled device by storing data on a storage medium using a storage medium programming device to generate a programmed storage medium, the data comprising control data, receiving the data stored on the programmed storage medium, providing the received data to a target user-controlled device and automatically controlling the target user-controlled device based on the control data received from the programmed storage medium, where the control data comprises at least one of a setting for the target user-controlled device and a command for the target user-controlled device to perform at least one function.

This invention separately provides user-controlled devices comprising a control panel that a user can operate to select at least one of a setting for the user-controlled device and a function that can be performed by the user-controlled device and a storage medium reading device associated with the user-controlled device that receives data stored on a storage medium and provides the data to the user-controlled device, where the data comprising control data which includes at least one of a setting for the user-controlled device and a command for the user-controlled device to perform the function.

This invention separately provides systems and methods for controlling a user-controlled device using a storage medium programming device usable to program a storage medium with at least control data, a storage medium reading device associated with the user-controlled device and which is usable to read control data from a storage medium programmed by the storage medium programming device, wherein the control data comprising at least one of a setting or a function of the user-controlled device.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 illustrates a block diagram of a first exemplary embodiment of a system for controlling a user-controlled device according to this invention;

FIG. 2 illustrates a block diagram of a second exemplary embodiment of a system for controlling a user-controlled device according to this invention;

FIG. 3 illustrates a first exemplary embodiment of a storage medium according to this invention;

FIG. 4 illustrates a second exemplary embodiment of a storage medium according to this invention;

FIG. 5 illustrates a third exemplary embodiment of a storage medium according to this invention;

FIG. 6 illustrates one exemplary embodiment of a graphical user interface of a personal computer according to this invention; and

FIG. 7 is a flowchart outlining one exemplary embodiment of a method for controlling an image forming device according to this invention.

### DETAILED DESCRIPTION OF PREFERRED EMBODIMENTS

Various exemplary embodiments, of the systems and methods of this invention allow a user to control a user-controlled device without using the control panel associated with the user-controlled device.

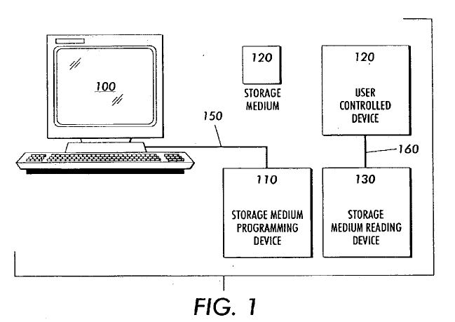

FIG. 1 illustrates a first exemplary embodiment of a system for controlling a user-controlled device according to the systems and methods of this invention. FIG. 1 shows a computer 100, which is associated with a storage medium programming device 110, a storage medium 120, and a storage medium reading device 130, which is associated with a user-controlled device 140.

As illustrated in FIG. 1, the computer 100 may communicate with the storage medium programming devices 110 via a link 150. Similarly, the storage medium reading device 140 may communicate with the user-controlled device via a link 160. It should be appreciated that the link 150 and the link 160 may be any suitable communication arrangement and can be a wired or wireless link to a network (not shown). The network can be a local area network, a wide area network, an intranet, the Internet, or any other distributed processing and storage network. Therefore, in various exemplary embodiments of the systems and methods of this invention, the storage medium programming device 110 and the computer 100 can be located remotely from each other and the storage medium reading device 130 and the user-controlled device 140 can be located remotely from each other.

In order to operate the target device, i.e., the desired user-controlled device 140, the user provides the programmed storage medium 120 to a storage medium reading device 130 associated with the target user-controlled device 140. The storage medium reading device 130 then reads or receives the stored data on the programmed storage medium 120 and the stored data causes the target user-controlled device 140 to perform the desired function and/or setting. The target user-controlled device 140 performs the desired function and produces the desired output without the user physically operating the control panel (not shown). In various exemplary embodiments, a single storage medium reading device may be used for multiple user controlled devices.

Various exemplary embodiments of the systems and methods according to this invention allow an individual, with a physical disability who has access to a storage medium programming device 110 and a computer 100, which may be equipped with special user-interface aids that allow the user to use the computer 100 with his/her physical disability, for programming the storage medium 120. The programmed storage medium 120 can then be provided, for example, placed on, into or otherwise associated with a storage medium reading device 130 which is associated with a target user-controlled device, such as, for example, the image forming device that the user desires to operate.

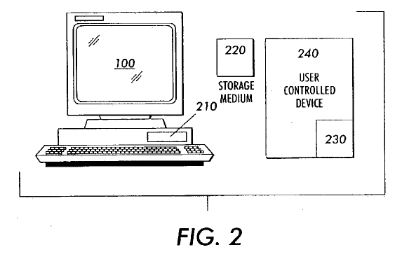

As illustrated in FIG. 2, in a second exemplary embodiment, a user-controlled device 240 has a storage medium reading device 230 incorporated therein. A storage medium programming device 210 may be similarly incorporated in a computer 200. It should be appreciated that in the systems and methods according to this invention, the user-controlled device may be located, for example, at a central location, such as, for example, at a commercial copy center, where a user can take their programmed storage medium to operate the user-controlled device to perform a desired function.

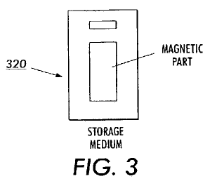

FIG. 3 illustrates a first exemplary embodiment of a storage medium according to this invention. As shown in FIG. 3, the storage medium may be a card 320 that is capable of storing data. For example, the card 320 may include a data strip such as a magnetic part 325 which can be used to store data. The card 320 may be, for example, credit card sized to make it easy for the user to transport the card from the location where the card is programmed to the storage medium reading device associated with the target device.

It should be appreciated that the storage medium can be implemented using any appropriate combination of alterable, volatile or non-volatile memory or non alterable, or fix, memory. The alterable memory, whether volatile or non-volatile, can be implement using any one or more of static or dynamic RAM, a floppy disk, a writable or re-writeable optical disk, flash memory or the like. Similarly, the non alterable or fixed memory can be implements using any one or more of ROM, PROM, EPROM, EEPROM, an optical ROM disk, such as a CD-ROM or DVD-ROM disk or the like.

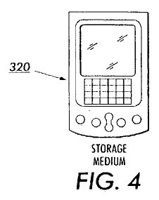

As shown in FIG. 4, a second exemplary embodiment of a storage medium is a personal digital assistant (PDA) 420, wherein the personal digital assistant 420 may be programmed with data via a personal computer. The data stored on the PDA can be beamed/scanned/read by the storage medium reading device associated with the target device. Alternatively, the personal digital assistant 420 may transmit or beam the data to the storage medium reading device or directly to the target device, thus also serving as a storage medium reading device.

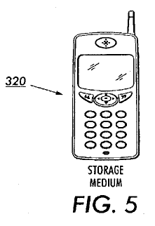

FIG. 5 illustrates a third exemplary embodiment of a storage medium according to the systems and methods of this invention. In the third exemplary embodiment, the storage medium is a digital or cellular phone 520 which can store data. Cellular phones are increasingly being provided with more and more features and capabilities. For example, many cellular phones already include, for example, similar functionality as personal digital assistants. Thus, the cellular phone 520 may be used as the storage medium and/or the storage medium reading device as described above.

In various exemplary embodiments of the systems and methods according to this invention, data regarding the desired settings and/or functions can be programmed or stored on the storage medium. Additionally, the data on which the desired function is to be performed can be programmed or stored on the storage medium. For example, if the user wishes to make a number of copies of a report, the user can store a command to make the number of copies, a command to staple each copy together and the report itself. In such a case, for example, the user need not place the report on the platen of the copier in addition to providing the programmed storage medium to the storage medium reading device associated with the copier.

Various user-controlled devices may be operated according to the systems and methods of this invention. As discussed above, a user-controlled device is any device which a user operates or controls via a control panel associated with the device. User-controlled devices are used in a wide-variety of environments and for a wide-variety of purposes. For example, user-controlled devices include, but are not limited to, copy machines, facsimile devices, scanners, printers, point of sale terminals, automated information/transaction kiosks, stereos, recording devices, televisions/VCRs, and computers.

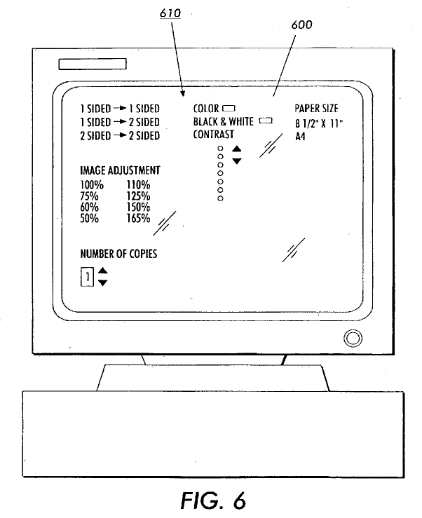

FIG. 6 illustrates one exemplary embodiment of a personal computer 600 equipped with a graphical user interface 610 resembling a control panel of a user-controlled device. A user may operate the computer 600 to select the various settings and/or functions in a manner similar to operating the control panel of the target user-controlled device to select those settings and/or functions. Thus, the user operates the computer to program a storage medium for example, via a storage medium programming device associated with the computer 600.

The graphical user interface 610 may provide a graphical depiction of a standard control panel for various user-controlled devices or a plurality of different graphical depictions for various user-controlled devices. For example, a standard control panel may be displayed for all copy machines. The standard control panel for copiers may include selections relating to for example, paper size, image rotation, image size, zoom, color, black and white, contrast, number of copies, number of sides, collation and/or stapling. Similarly, for example, a standard control panel for a multifunction device may include the forgoing selections, a mode selection (i.e., fax mode, scan mode, copy mode, color picture copier mode, etc.), and additional function-specific (e.g., fax, scan, or color) selections.

By allowing the user to operate a graphical depiction of the target device's control panel and/or a standard control panel for the target device on a computer which accommodates the user's disabilities, the user can access settings and/or functions that might otherwise be inaccessible. For example, the user may increase the font of the characters being displayed in order to have a larger view of the selections and/or information recited on the control panel. Even individuals with no physical disabilities may chose to operate user-controlled devices via programmed storage mediums for convenience and/or so that another individual may operate the target device without detailed instructions from the user.

It should be appreciated that the computer which the individual uses to program the storage medium can have special features, such as, for example, a special keyboard, a special mouse, a voice-recognition system and/or a special physical arrangement, such as a height at which the user can easily access the computer. The user can use the special features with the computer in order to select the desired commands, functions, and/or settings instead of with the control panel of the user-controlled device.

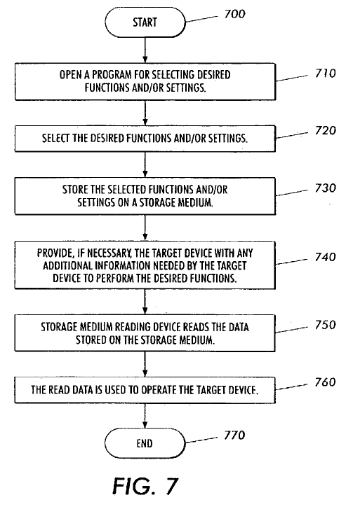

FIG. 7 is a flowchart illustrating an exemplary embodiment of a process of controlling a user-controlled device using a storage medium. Control begins in step 700, and continues to step 710 where a user initiates a program for selecting desired functions, settings and/or commands of a target user-controlled device. In step 720, the user selects the desired functions, settings and/or commands. Then, in step 730, the selected functions, settings and/or commands are stored on the storage medium using a storage medium programming device. Control continues to step 740, where the target user-controlled device is provided with any additional information, such as, for example, documents, that the user-controlled~system needs to carry out the desired operations. Next, in step 750, a storage medium reading device reads or receives the data stored on the storage medium. Then, in step 760, the read or received data controls the target user-controlled device in accordance with the settings, functions and/or commands contained in the data stored on the storage medium. Control continues to step 770, where the process ends.

While this invention has been described in conjunction with the exemplary embodiments outlined above, it is evident that many alternatives, modifications and variations will be apparent to those skilled in the art. Accordingly, the exemplary embodiments of these systems and methods according to this invention, as set forth above, are intended to be illustrative, not limiting. Various changes may be made without departing from the spirit and scope of this invention.

What is claimed is:

1. A method for controlling a target user-controlled device, the method comprising:
storing data on a storage medium using a storage medium programming device to generate a programmed storage medium, the data comprising control data;
receiving the data stored on the programmed storage medium;
providing the received data to a target user-controlled device; and
automatically controlling the target user-controlled device based on the control data received from the programmed storage medium, the control data comprising at least one of a setting for the target user-controlled device and a command for the target user-controlled device to perform at least one function.

2. The method of claim 1, further comprising selecting control data from a graphical depiction of a control panel having a plurality of functions and settings.

3. The method of claim 1, wherein receiving the control data stored on the programmed storage medium comprises reading the control data using a storage medium reading device associated with the target user-controlled device.

4. The method of claim 1, wherein the target user-controlled device is at least one of a copy machine, a printer, a fax machine, a scanner, and a personal computer.

5. The method of claim 4, wherein storing data on a storage medium using a storage medium programming device comprises storing at least one of a paper-size setting, a contrast setting, an image-size setting, a fax setting, a copy setting and a scan setting.

6. The method of claim 5, wherein storing data on a storage medium comprises storing object data on which the target user-controlled device is to carry out the at least one setting or function based on the control data received from the storage medium.

7. The method of claim 1, wherein storing the control data on a storage medium comprises storing control data on at least one of a portable card including a magnetic part, a personal digital assistant, a digital telephone and a cellular telephone.

8. A user-controlled device, comprising:.
a control panel that a user can operate to select at least one of a setting for the user-controlled device and a function that can be performed by the user controlled device; and
a storage medium reading device associated with the user-controlled device that receives data stored on a storage medium and provides the data to the user-controlled device, the data comprising control data which includes at least one of a setting for the user-controlled device and a command for the user-controlled device to perform the function.

9. The user-controlled device of claim 8, wherein the user-controlled device is at least one of a copy machine, a printer, a fax machine, a scanner, and a personal computer.

10. The user-controlled device of claim 9, wherein the at least one desired setting is at least one of a paper-size setting, a contrast setting, an. image-size setting, a color setting, a fax setting, a copy setting and a scan setting.

11. The user-controlled device of claim 8, wherein the data stored on the storage medium further comprises object data on which the user-controlled device is to carry out the at least one setting or function.

12. The user-controlled device of claim 8, wherein the storage medium is at least one of a portable card including a magnetic part, a cellular telephone, a digital phone and a personal digital assistant.

13. A system for controlling a user-controlled device, comprising:
a storage medium programming device usable to program a storage medium with at least control data; and
a storage medium reading device associated with the user-controlled device and which is usable to read control data from a storage medium programmed by the storage medium programming device, wherein the control data comprising at least one of a setting or a function of the user-controlled device.

14. The system according to claim 13, further comprising a storage medium that stores at least control data.

15. The system according to claim 14, wherein the storage medium is at least one of a portable card including a magnetic part, a digital phone, a cellular phone, and a personal digital assistant.

16. The system of claim 13, further comprising a computer associated with the storage medium programming device.

17. The system according to claim 16, wherein the computer includes a display for displaying a graphical depiction of a control panel which can be used to select at least one of a plurality of settings and a plurality of functions for the user-controlled device.

18. The system according to claim 17, wherein the display shows a graphical depiction of a control panel of the user controlled device.

19. The system according to claim 13, wherein the storage medium stores object data on which the user-controlled device is to carry out the at least one setting or function of the user-controlled device.

20. The system according to claim 16, wherein the storage medium programming device is part of the computer.

21. The system according to claim 13, wherein the storage medium reading device is part of the user-controlled device.

22. The system according to claim 13, wherein the at least one setting or function of the user-controlled device includes at least one of a paper-size setting, a contrast setting, an image-size setting, a fax setting, a copy setting, a color setting, and a scan setting.

23. The system according to claim 13, wherein the user-controlled device is at least one of a copy machine, a printer, a fax machine, a scanner, and a personal computer.
